(19) United States
(12) Patent Application Publication
(10) Pub. No.: US 2018/0038646 A1
(43) Pub. Date: Feb. 8, 2018

(54) MULTIPLE AXES ROTARY AIR NOZZLE

(71) Applicant: Sonic Air Systems, Inc., Brea, CA (US)

(72) Inventor: Daniel J. VanderPyl, Brea, CA (US)

(21) Appl. No.: 15/228,951

(22) Filed: Aug. 4, 2016

(51) Int. Cl. F26B 21/00; B05B 15/06; B05B 3/02; F26B 15/18; B05B 1/00

(52) U.S. Cl. CPC F26B 21/004; F26B 15/18; B05B 1/005; B05B 3/02; B05B 15/065

(57) ABSTRACT

A method to deliver high velocity air from a rotating nozzle manifold which continuously passes through multiple rotational axes so as to project the nozzle discharge air into virtually every spherical direction in order to impact all surfaces on or within a structure. With the use of two rotating air couplings operating in series and each fastened to their own air manifolds, and having small thrust jets on each manifold powered by the same pressurized air supply used for the high velocity discharge nozzles, rotation of the high velocity air nozzle manifold in the X and Y axes are achieved.

### BACKGROUND

### Field

The present disclosure relates to air blowers and in particular in one embodiment to an air blower that can rotate about multiple axes.

### Description of the Related Art

In many industries, there are a variety of structures that are manufactured, used in production and processing, or utilized for storage and transportation of another product. These structures come in an assortment of geometric shapes and sizes, with overall volume ranging from one cubic foot to several thousand cubic feet and they include but are not limited to frames, chambers, buildings, vessels and tanks in both stationary and portable designs alike.

During either the manufacturing process of these structures or their utilization it is common for substances such as liquids, coatings, dust and debris to be purposefully applied to the interior surfaces or to experience accidental accumulation of substances. These substances include but are not limited to liquids such as paints, coatings, chemicals, consumable products, cleaning solutions, cooling fluids and heating fluids or it can be particles consisting of flakes, powders and fibers. Whether purposely applied to a structure or simply building up on the surfaces as a result of airborne spray, vapors or particles settling on them without intent, the acceleration of surface moisture reduction or removal of dust and debris in as short a time as possible is often a significant benefit to worker safety, product quality or production efficiency.

The methods for surface moisture reduction include the use of radiant heat, forced air convective heat, manual wiping with rags, motor driven oscillating fans, hand held air nozzles from a blower or compressor or simply natural evaporation resulting from exposure to ambient air. The methods for liberating particles such as dust and debris includes using motor driven oscillating fans, hand held air nozzles from a blower or compressor and manual wiping with rags or brushes.

### SUMMARY

An aspect of the present disclosure is a system for directing air under pressure at an article using a rotational air distribution manifold with multiple air distribution chambers that correspond to multiple rotational axes. The system for directing air under pressure can comprise a blower for delivering pressurized air through an inlet duct fluidly coupled with the rotational air distribution manifold. Such a system has the advantage of being able to ensure that pressurized air is blowing onto virtually all internal or external surfaces of the article to accelerate surface drying or particle removal from any geometric shape. In some configurations, the result of such a system is a continuous spherical spray pattern of high velocity air discharge.

In another aspect of the present disclosure, the rotation of the air distribution chambers about the multiple rotational axes requires no gears, belts, motors or other external drive components and instead achieves rotation by small thrust jets. Optionally, the speed of rotation of the air distribution chambers can be optimized for each application using fully adjustable valves in the thrust jets. In some nonlimiting embodiments, the air distribution chambers utilize air valves or nozzles to create thrust in order to produce rotational motion of each chamber at speeds from 1 to 200 RPM.

In another aspect of the present disclosure, the air distribution manifold includes the use of two continuously rotating air distribution chambers operating in series. The pressurized air supplied by a blower or compressor can pass from the stationary inlet duct of each rotational coupling into a rotating perpendicular air transfer point which serves as the air inlet duct to each air distribution chamber. The pressurized air can be communicated from the blower through the conduit and the inlet duct, into the first air chamber, into the second air chamber, and out through a first thrust jet and the first nozzle.

In another aspect of the present disclosure, the first air distribution chamber comprises an elongate chamber having a first end laterally spaced from a second end along a central axis. The inlet duct can be located between the first end and the second end of the first air distribution chamber and can optionally define a first axis of rotation transverse to the central axis. Optionally, the first air distribution chamber further comprises a second thrust jet located on the second end of the first air distribution chamber and configured to emit a jet of air in a second tangential direction relative to the first axis of rotation.

In another aspect of the present disclosure, a second air distribution chamber can be located on the first end of the first air distribution chamber and can define a second axis of rotation. Optionally, the second axis of rotation can be parallel to the central axis of the first air distribution chamber. The second air distribution chamber can have a first nozzle directing air under pressure in a first outward direction. Optionally, the second air distribution chamber can have first and second lateral ends and the first nozzle can be on one of the first and second lateral ends. In another aspect of the disclosure, the second air distribution chamber can comprises a second nozzle. The second nozzle can optionally be on one of the first and second lateral ends opposite the first nozzle.

In another aspect of the present disclosure, a first thrust jet can be located on at least one of the first and second lateral ends of the second air distribution chamber. Optionally, it can be and configured to direct a jet of air in a first tangential direction relative to the second axis of rotation. In some embodiments, the thrust jet can be located at a location offset from the second axis of rotation. In other embodiments, the thrust jet can be located at a location aligned with the second axis of rotation.

In another aspect of the present disclosure, the second air distribution chamber further comprises a second nozzle on one of the first and second lateral ends opposite the first nozzle. Optionally, the second nozzle is directed in a second outward direction, the second outward direction being substantially opposite the first outward direction.

In another aspect of the disclosure, a first rotational coupling can join the first air distribution chamber to the inlet duct and permit rotation of the first air distribution chamber relative to the inlet duct and about the first axis of rotation. In another aspect of the disclosure, a second rotational coupling can joins the first air distribution chamber to the second air distribution chamber and can permit rotation of the first air distribution chamber relative to the second air distribution chamber about the second axis of rotation.

In another aspect of the disclosure, the rotational air distribution manifold comprises a counterweight. Optionally, the counterweight is on the second end of first air distribution chamber opposite the second air distribution chamber. The counterweight can function to balance the rotating parts of the distribution manifold including the first and second air distribution chambers. The distribution manifold can further comprise multiple counterweights.

In another aspect of the disclosure, the first air distribution chamber comprises a third nozzle on. Optionally, the third nozzle is located between the first end and the second end of the first air chamber.

In another aspect of the disclosure, an apparatus for directing air under pressure comprises a first air chamber having an inlet duct, the inlet duct defining a first axis of rotation and comprising a first rotational coupling.

In another aspect of the disclosure, a second air chamber is fluidly coupled with the first air chamber at an air passage. Optionally, the air passage defines a second axis of rotation and comprising a second rotational coupling;

In another aspect of the disclosure is a method for directing a flow of air optionally comprising the steps of delivering a flow of air into a first chamber, emitting a first jet of air from the first chamber and thereby rotating the first chamber about a first axis, directing the flow of air from the first chamber into a second chamber, emitting a second jet of air from the second chamber and thereby rotating the second chamber about a second axis, and discharging the flow of air from the second chamber in an outward direction.

In another aspect of the disclosure is a method comprising the steps of discharging the flow of air is discharged in a hemispherical sweep pattern, or in a spherical sweep pattern.

In another aspect of the disclosure is an apparatus for directing a flow of air, the apparatus optionally comprising an air distribution structure having a longitudinal axis of rotation and a transverse axis of rotation, the air distribution structure configured with at least one primary nozzle to emit a flow of air in a direction along a laterally extending swath.

Optionally, the air distribution structure is equipped with at least a first thrusting air jet at a first location offset from the longitudinal axis of rotation and oriented tangentially relative to the longitudinal axis of rotation and a second thrusting air jet at a second location offset from the transverse axis of rotation and oriented tangentially relative to the transverse axis of rotation and configured so as to deliver sufficient thrust to the first thrusting air jet to rotate the air distribution structure about the longitudinal axis of rotation and to deliver sufficient thrust to rotate the air distribution structure about the transverse axis of rotation, thereby sweeping the laterally extending swath in an outward direction.

In another aspect of the disclosure is an apparatus for directing a flow of air in a laterally extending swath, the laterally extending swath is being a hemispherical sweep pattern, or a spherical sweep pattern.

In another aspect of the disclosure, rotating air distribution manifold rotates about the first and second axis of rotation using only the air supplied by a blower or compressor. Optionally, there are no motors, gears or control devices except for the integral thrust nozzles to create rotation about the first axis of rotation. Optionally, there are no motors, gears or control devices except for the integral thrust nozzles to create rotation about the second axis of rotation. Optionally, there are no motors, gears or control devices except for the integral thrust nozzles to create rotation about the first and second axes of rotation.

In another aspect of the disclosure, the air nozzles on the second air distribution chamber are at differing diagonal angles to the direction of rotation for maximum rotational axes of air impact coverage. Optionally, there are two air nozzles on the second air distribution chamber and the two air nozzles are pointed in opposite directions from each other.

In another aspect of the disclosure, the first and second air distribution chambers each have one or more thrust nozzles directed tangentially to the first and second axes of rotation, respectively. Optionally, the amount of air emitted from at least one thrust nozzle on the first air distribution chamber is adjustable so that the first air distribution chamber can rotate about the first axis of rotation at any speed, in clockwise or counter clockwise direction and is not dependent on or required to run at the same rpm as the second air distribution chamber. Optionally, the amount of air emitted from at least one thrust nozzle on the second air distribution chamber is adjustable so that the second air distribution chamber can rotate about the second axis of rotation at any speed, in clockwise or counter clockwise direction and is not dependent on or required to run at the same rpm as the first air distribution chamber.

Another aspect of the disclosure comprises a system for directing air under pressure. The system can include an air distribution manifold that comprises a first air distribution chamber having a first end laterally spaced from a second end along a longitudinal axis, the first air distribution chamber having an inlet duct that is fluidly coupled to the blower, the inlet duct located between the first end and the second end of the first air distribution chamber and defining a first axis of rotation transverse to the longitudinal axis. A first rotational coupling joins the first air distribution chamber to the inlet duct and permits rotation of the first air distribution chamber relative to the inlet duct about the first axis of rotation. A second air distribution chamber is located on the first end of the first air distribution chamber and defines a second axis of rotation parallel to the longitudinal axis of the first distribution chamber. The second air distribution chamber can have first and second lateral ends and a first nozzle for directing air under pressure in a first outward direction. A second rotational coupling can join the first air distribution chamber to the second air distribution chamber and permits rotation of the first air distribution chamber relative to the second air distribution chamber about the second axis of rotation. In certain arrangements, the system can optionally include a first thrust jet located on at least one of the first and second lateral ends of the second air distribution chamber and configured to emit a jet of air tangentially relative to the second axis of rotation and/or a second thrust jet located on the second end of the first air distribution chamber and configured to emit a jet of air tangentially relative to the first axis of rotation.

Another aspect of the disclosure comprises an apparatus for directing air under pressure. The apparatus can include first air distribution chamber having an air inlet, the air inlet defining a first axis of rotation and comprising a first rotational coupling. A second air distribution chamber can be fluidly coupled with the first air chamber at an air passage, the air passage defining a second axis of rotation and comprising a second rotational coupling. The second air distribution chamber further can comprise a first nozzle for directing air under pressure in an outward direction. In certain arrangements, the apparatus can optionally include a thrust jet located on the second air distribution chamber that is configured to direct a jet of air tangentially relative to the second axis of rotation sufficient to rotate the second air chamber about the second axis of rotation and/or a second thrust jet located on the first air chamber and configured to direct a jet of air tangentially relative to the first axis of rotation sufficient to rotate the first air chamber about the first axis of rotation.

Another aspect of the disclosure comprises a method for directing a flow of air comprising delivering a flow of air into a first distribution chamber; rotating the first distribution chamber about a first axis; directing the flow of air from the first distribution chamber into a second distribution chamber; rotating the second distribution chamber about a second axis; discharging from a nozzle the flow of air from the second distribution chamber in an outward direction. The method can optionally include emitting a jet of air from the second distribution chamber and thereby rotating the second distribution chamber about the second axis and/or rotating the first distribution chamber about a first axis comprises emitting a jet of air from the first distribution chamber.

For purposes of summarizing the invention and the advantages achieved over the prior art, certain objects and advantages of the invention have been described in this application. It is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

All of these embodiments are intended to be within the scope of the invention herein disclosed. These and other embodiments of the present invention will become readily apparent to those skilled in the art from the following detailed description of the embodiments having reference to the attached figures, the invention not being limited to any particular embodiment(s) disclosed.

### BRIEF DESCRIPTION OF THE DRAWINGS

Exemplary embodiments are illustrated in the accompanying drawings, which are for illustrative purposes only. The drawings comprise the following figures, in which like numerals indicate like parts.

FIG. 1 is schematic elevation view of an assembly for directing air under pressure onto articles passing on a conveyor belt.

FIG. 2 is a schematic side view of an embodiment of a rotational air distribution manifold having two axes of rotation.

FIG. 3 is a perspective view an embodiment of a rotational air distribution manifold having two axes of rotation.

FIG. 4 is an front view of an embodiment of a rotational air distribution manifold having two axes of rotation.

FIG. 5 is a back view of an embodiment of a rotational air distribution manifold having two axes of rotation.

FIG. 6 is a side view of an embodiment of a rotational air distribution manifold having two axes of rotation.

FIG. 6A is a sectional view taken along the line 6A in FIG. 6.

FIG. 6B is a detail view of FIG. 6A.

FIG. 7 is a side view of an embodiment of an air distribution chamber.

FIG. 8 is an exploded view of an embodiment of a rotational air distribution manifold having two axes of rotation.

FIG. 9 is a perspective view of an embodiment of an rotational coupling.

FIG. 10A is an illustration of an embodiment of a rotational air distribution manifold having three air distribution chambers.

FIG. 10B is an illustration of an embodiment of an air distribution chamber.

FIG. 10C is an illustration of an embodiment of an air distribution chamber.

FIG. 11A is an illustration of an embodiment of the present disclosure and its air spray pattern.

FIG. 11B is an illustration of an embodiment of the present disclosure and its air spray pattern.

### DETAILED DESCRIPTION

Although the invention has been disclosed in the context of certain embodiments and examples, it will be understood by those skilled in the art that the invention extends beyond the specifically disclosed embodiments to other alternative embodiments and/or uses and obvious modifications and equivalents thereof. Accordingly, the invention is not intended to be limited by the specific disclosures of embodiments herein. Thus, the scope of the claims appended hereto is not limited by any of the particular embodiments described herein. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components. For purposes of comparing various embodiments and arrangements, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

Certain terminology may be used in the following description for the purpose of reference only, and thus are not intended to be limiting. For example, terms such as “above” and “below” refer to directions in the drawings to which reference is made. Terms such as “proximal,” “distal,” “front,” “back,” “rear,” and “side” describe the orientation and/or location of portions of the components or elements within a consistent but arbitrary frame of reference which is made clear by reference to the text and the associated drawings describing the components or elements under discussion. Such terminology may include the words specifically mentioned above, derivatives thereof, and words of similar import.

An aspect of certain embodiments described herein is a method to deliver high velocity air from a rotating air distribution manifold which can continuously pass through multiple rotational axes so as to discharged air into every or substantially every spherical direction in order to impact all or substantially all surfaces on or within a structure. Certain embodiments utilize two rotating air couplings that operate in series. Each air rotating air coupling can be coupled to a corresponding air manifold. One or both air manifolds can have one or more small thrust jets that can be self-powered by the same pressurized air supply that used for one or more high velocity discharge nozzle through which high velocity air can flow. In this manner, rotation of the high velocity air nozzle manifold in the X and Y axes can be achieved. An advantage of certain embodiments is that high velocity air from the high velocity air nozzles can continuously pass through multiple rotational axes to ensure that air is blowing onto all or substantially all internal or external surfaces of a structure. With the use of two continuously rotating air coupling assemblies operating in series, through which rotation is achieved by the small thrust jets, certain embodiments do not requires gears, belts, motors or other external drive components. In certain embodiments, the speed of rotation can also fully adjustable by adjusting the size and/or orientation of these thrust jet to optimize for each application. The pressurized air supplied by a blower or compressor passes can pass through a stationary shaft of each air coupling into a rotating perpendicular air transfer point which can serves as the inlet duct to each air distribution chamber. The result can be a continuous spherical motion of high velocity air discharge to accelerate surface drying and/or particle removal from a wide variety of geometric shapes.

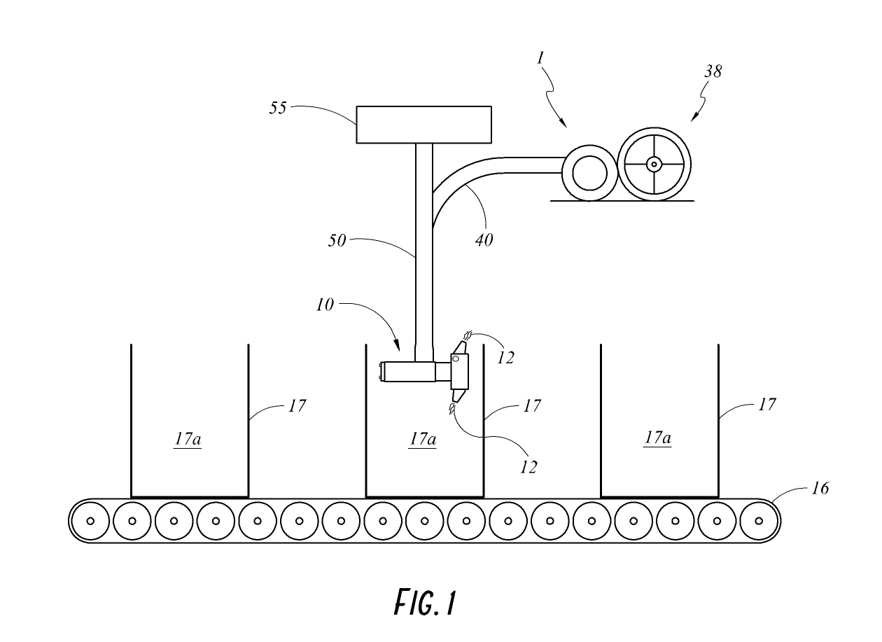

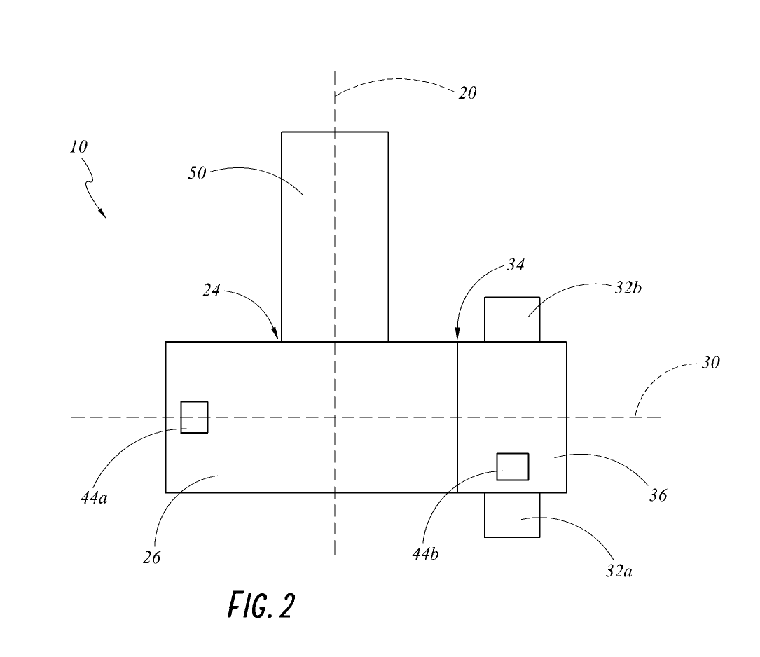

FIG. 1 is a schematic illustration of one embodiment of an air blower assembly 1 for directing air under pressure onto articles 17. The illustrated embodiment includes a rotational air distribution manifold 10 for directing a flow of air 12. Certain features and aspects of certain embodiments of the air distribution manifold 10 will be described in additional detail below with respect to FIGS. 2-11B. In the illustration shown, the articles 17 are barrel-like objects having an interior space 17a that requires a pressured air for purposed such as drying or removing particles. In some embodiments of the air blower assembly 1, passing articles 17 can be on a conveyor system 16 and pass by or underneath the air distribution manifold 10.

In the illustrated arrangement, the air blower assembly 1 can include the rotational air distribution manifold 10, which can be coupled to air blower 38 through a hollow air conduit 40. One suitable air fan that can be utilized as the air blower 38 is the Sonics 70 centrifugal blower manufactured and sold by Sonic Air Systems, located at Sonic Air Systems, 1050 Beacon St, Brea, Calif. 92821. The air blower 38 and the conduit 40 can function to deliver a supply of pressurized air for distribution through manifold 10.

In some embodiments of the disclosure, the rotational air distribution manifold 10 can be mounted to a shaft 50 and lowering mechanism 55 and alternatively raised and lowered into interior space 17A of passing article 17. In such embodiments, the manifold 10 can efficiently distribute pressurized air against all or substantially of the surfaces of interior space 17a. Various embodiments of the manifold 10 are described below. In certain embodiments, the shaft 50 and lowering mechanism 55 can be omitted and the manifold 10 can deliver the pressurized air from a fixed location relative to article 17. In certain embodiments, the shaft 50 and lowering mechanism 55 can be modified to provide translation and/or rotation along and/or about additional axes. In other embodiments, the manifold 10 can remain stationary and the article 17 can move relative to the manifold 10 along the conveyer 16 and/or both the manifold 10 and the article 17 can be configured to be moved.

FIG. 2 is a schematic view of an embodiment of air distribution manifold 10 that can be used with the assembly of FIG. 1. The manifold 10 can comprise a first axis of rotation 20 and a second axis of rotation 30. In the illustrated embodiment, the first rotational coupling 24 can be coupled the shaft 50 and a first air distribution chamber 26 such that the first air distribution chamber 26 may rotate along the first axis of rotation 20 with respect to the shaft 50. The shaft 50 may optionally be coupled to an air blower 38 as described with reference to FIG. 1 to deliver a supply of pressurized air into first air distribution chamber 26 through an inlet duct. In some embodiment, the inlet duct comprises a the first rotational coupling 24. In some embodiments, the first rotational coupling 24 is configured to allow for 360 degrees of rotation between the first air distribution chamber 26 and the shaft 50.

The first air distribution chamber 26 can include a thrust jet 44a. In some embodiments, the thrust jet 44a can be at a location on the air distribution chamber 26 that is offset from the first rotational axis 20. The thrust jet 44a can be positioned to direct the pressurized air that flows through the thrust jet 44 in a tangential direction relative to the first rotational axis 20 such that it can cause rotation of the first air distribution chamber 26 on the first rotational coupling 24 and about the rotational axis 20. In certain embodiments, the first air distribution chamber 26 does not include a thrust jet 44a.

The first air distribution chamber 26 can be coupled to a second air distribution chamber 36 by a second rotational coupling 34. The second rotational coupling 34 can allow the second air distribution chamber 36 to rotate about the second rotational axis 30. The second air distribution chamber 36 can include thrust jet 44b at a location offset from second rotational axis 30. The thrust jet 44b can be positioned to direct the pressurized air that flows through it in a tangential direction relative to the second rotational axis 30 such that it can cause the rotation of the second air distribution chamber of 36 to rotate on second rotational coupling 34 and about the second axis 30. In certain embodiments, the thrust jet 44b can be omitted.

In some embodiments, the second air distribution chamber 34 comprises a first air nozzle 32a directed in an exterior direction from the second air distribution chamber 34. The air nozzle 32a can be fluidly coupled with the second air distribution chamber 34 such that the pressurized air flows from the air distribution chamber 36 through the air nozzle 32a. In some embodiments of air nozzle 32a, the pressurized air is directed at a first outward angle relative to the first axis of rotation 20. In certain embodiments of the second air distribution chamber 36, a second air nozzle 32b can be included and directed in a second outward angle relative to the first axis of rotation 20. In certain arrangements, the air distribution chamber 34 can be provided with only one air nozzle or more than two air nozzles. Although not illustrated, it is anticipated that the first air distribution chamber 26 could also include one or more air nozzles.

The shaft 50 is in some embodiments a hollow shaft for delivering at air under pressure through the rotational coupling 24 and into the first air distribution chamber 36. In some embodiments at least a portion of the pressurized air may exit first air distribution chamber 36 through the thrust jet 44a. The second air distribution chamber 36 is, in turn, fluidly coupled with the first air distribution chamber 26 through the second rotational coupling 34 such that the pressurized air flows from the first air distribution chamber 26 into the second air distribution chamber 36. From the second air distribution chamber 36, the pressurized air can flow can exit through any one of the thrust jet 44b, the air nozzle 32a or the air nozzle 32b, or any combination thereof.

In certain embodiments the pressurized air flowing from the thrust jet 44a causes the first air distribution chamber 26 and the second air distribution chamber 36 to rotate about first rotational axis 20. In certain embodiments, the pressurized air flowing into the second air distribution chamber 36 and out through the second thrust jet 44b causes the second air distribution chamber 36 to rotate about the second rotational axis 30.

In some embodiments of the present disclosure, the air distribution chamber 26 can rotate about the first rotational axis 20 while the second air distribution chamber 36 can simultaneously rotate about the second rotational axis 30. In such an embodiment, the pressurized air can exit through the air nozzles 32a, 32b in a multitude of different directions in a swath air distribution pattern. In some embodiments, the pattern is hemispherical while in others, it is fully spherical.

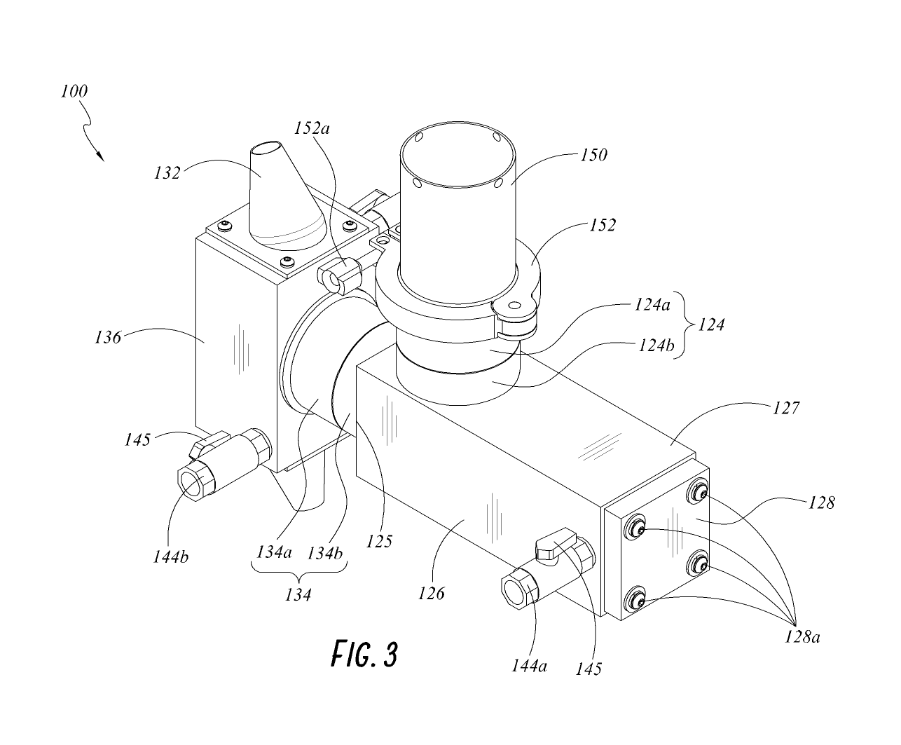

FIG. 3 is another embodiment of a rotational air distribution manifold 100 having two axis of rotation which can be use with the system 10 of FIG. 1. In this embodiment, air shaft 150 is rotationally coupled to a first air distribution chamber 126 by a first rotational coupling 124. The first air distribution chamber 126 is coupled to a second air distribution chamber 136 by a second rotational coupling 134. The second air distribution chamber comprises a first and second air nozzle 132a, 132b fluidly coupled to direct a flow of pressurized air in an outward direction. The first air distribution chamber 126 can include a first thrust jet 144a at a location offset from the first rotational coupling 124. The second air distribution chamber 136 can includes a second thrust jet 144b at a location offset from the second rotational coupling 134. While two air nozzles 132a, 132b are illustrated, in certain embodiments one or more air nozzles can be utilized.

A supply of pressurized air through the shaft 150 can be delivered to the first chamber 126 and the second chamber 136. A portion of the supply of pressurized air can be emitted from the first thrust jet 144a and can provide a rotational force to rotate the first chamber 126 about the first rotationally coupling 124. Another portion of the pressurized air can be emitted from the second thrust jet 144b and can provide a rotational force to rotate the second chamber 136 about the second rotational coupling 134. Another portion of the pressurized air can be discharged from the air nozzles 132a, 132b. Under a sustained supply of pressurized air, both the first and second chambers 126, 136 can rotate simultaneously and can discharge pressurized air from the air nozzles 132a, b in an outward directed swath.

In the illustrated arrangement, the shaft 150 can comprise a hollow sleeve that can be coupled with an air conduit for delivering a pressurized air to the rotational air distribution manifold 100. The shaft 150 can be removable coupled with one of air distribution chamber 126 or the first rotational coupling 124 through a clamp 152. The clamp 152 can be secured around the shaft 150 and the first rotational coupling 124 through a bolt 152a.

In the illustrated embodiment, the first rotational coupling 124 can comprise an upper section 124a and a lower section 124b. The shaft 150 can form the upper section 124a and the first air distribution chamber 126 can form the lower section 124b. The first rotation of coupling 124 can be configured to allow for a flow of pressurized air from shaft 150 to flow through first rotational coupling 124 into first air distribution chamber 126.

In the illustrated embodiment, the first rotation air coupling 124 can allow the first air distribution chamber 126 to rotate with respect to have shaft 150. In the illustrated arrangement, the air distribution chamber 126 can advantageously rotate relative to the shaft 150 on first rotational air coupling 124 with respect to shaft 150 in 360°.

In the illustrated embodiment, the first chamber 126 comprises the thrust jet 144a on a second end 127 of the first air distribution chamber 126. The thrust jet 144a can be offset from the first rotational coupling 124 such that the thrust jet 144a emits pressurized air tangentially relative to the first rotational coupling 124 and can thereby create rotation of the first air distribution chamber 126. In certain other embodiments, the thrust jet 144a can be omitted. Optionally, rotation of the first air distribution chamber 126 about the first axis of rotation 120 can be achieved by the nozzle 132.

In embodiments previously described above or below, rotation of the first air distribution chamber about the first rotational axis of rotation of the second air dissolution chamber about the second air second rotational axis can be achieved through the small through the thrust jet. In some embodiments of the present disclosure, the air nozzle 32 or air nozzles 132a, b themselves can also assist with the rotational movement but in the illustrated embodiments it is primarily the thrust jets 144 that assist with the rotational movement.

The thrust jet 144a can advantageously include an adjustment mechanism 145 for adjusting the flow of the pressurized air that can flow through thrust jet 144a. I the illustrated embodiment, the thrust jet adjustment mechanism 145 can be a closable valve having an adjustment handle, which can be used to adjust the open area through which air can flow and ultimately the amount of air flowing through the thrust jet 144a. In certain embodiments, the thrust jet adjustment mechanism 145 can be omitted and/or modified. In certain embodiments, the adjustment mechanism 145 comprises a threaded member extending through a threaded bore in the thrust jet 144a and can optionally variably extend at least partially into an air passageway extending through thrust jet 144a to at least partially obstruct the passageway. Thus, by threading the adjustment mechanism 145 further into the thrust jet 14a an cross-sectional area of the air passageway extending through thrust jet 144a can be reduced to control the amount of air flowing through the passageway. In certain embodiments, the thrust jet adjustment mechanism 145 can be used to adjust the rotational velocity of the first air distribution chamber 136 in the range of approximately 1 RPM to 200 RPMs.

In the illustrated embodiment, the first air distribution chamber 126 can comprise a counterweight 128. The counterweight 128 can function as a balance to the weight of the second air distribution chamber 126. In the illustrated arrangement, the counterweight 128 can be offset from the rotational coupling first rotational coupling 124 or on end 127 of the first air distribution chamber. 126 The counterweight 128 can be fastened to the first chamber 126 by mechanical fasteners 128a, which in the illustrated embodiment in are screws. The mechanical fasteners 128a can also include bolts, glue, press fit, and other known attachment in other embodiments. In certain embodiments, the counterweight 128 is formed as an integral part of first air distribution chamber 126. The counterweight 128 can at an end of the first chamber 126 opposite the second chamber 136 in certain arrangements. In certain embodiments, the counter weight 128 can be omitted or positioned at a different location.

The first air distribution chamber 126 can optionally be fluidly coupled with second air chamber 136 through second rotational coupling 134. Second rotational coupling 134 can optionally allow rotation of the second air distribution chamber 136 in 360 degrees relative to the first air distribution chamber 126. Optionally, second air coupling 134 comprises a first section 134a and a second section 134b. First section 134a can be a part of first air distribution chamber 126 and second section 134b can be a part of second air distribution chamber 136.

The second air distribution chamber 136 can optionally comprise the air nozzles 132a, 132b. The air nozzles 132a, 132b can be fluidly coupled with the second air distribution chamber 136 such that the air nozzles 132a, 132b can admit the pressurized air that flows from the first air distribution chamber 126 through the second rotational coupling 134 into the second air distribution chamber 136.

Optionally, the second air distribution chamber 136 can comprise a thrust jet 144b. The thrust jet 144b can be disposed on the second air distribution chamber 136 at a location offset from the rotational coupling second rotational coupling 134. The thrust jet 144b can be configured to emit a portion of the pressurized air flowing into the second air distribution chamber 136. The emitted pressured air can be configured to provide a rotational velocity to second air distribution chamber 136 about rotational coupling 134. In certain other embodiments, the thrust jet 144b can be omitted. Optionally, rotation of the second air distribution chamber 136 about the second axis of rotation 130 can be achieved by the nozzle 132.

Optionally, thrust jet 144b can comprise an adjustment mechanism 145 for adjusting the velocity of the pressurized air allowed to emit. In some embodiments adjustment mechanism 145 is a closure valve having an exterior handle. The adjustment mechanism 145 can be a closable valve having an adjustment handle, which can be used to adjust the open area through which air can flow and ultimately the amount of air flowing through the thrust jet 144b. In certain embodiments, the thrust jet 144b can be omitted and/or positioned at a different location and/or include additional thrust jets. In certain embodiments, as with the adjustment mechanism 145 described above, the adjustment mechanism 145 can comprise a threaded member extending into the thrust jet 144b that can at least partially variably obstruct an air passageway extending through thrust jet 144b. In certain embodiments, the thrust jet adjustment mechanism 145 can be used to adjust the rotational velocity of the second air distribution chamber 136 in the range of approximately 1 RPM to 200 RPMs.

Optionally, the supply of pressurized air flows through the parts of the air distribution manifold 100 in series. In the illustrated embodiment, the air flows from shaft 150 through the first rotational coupling 124 into the first distribution chamber 126, out of the first chamber 126 through the second rotational coupling 134 and into the second air distribution chamber 136, and out of the air nozzles 132a, 132b. Optionally, the pressurized air may emit from the thrust jet 144a to provide a rotational velocity of the first air distribution chamber 136 and the second air distribution chamber about the rotational coupling 124. Optionally, the pressurized air emitting from the thrust jet 144b provides a rotational velocity to the second chamber 136 about the second rotational air coupling 134.

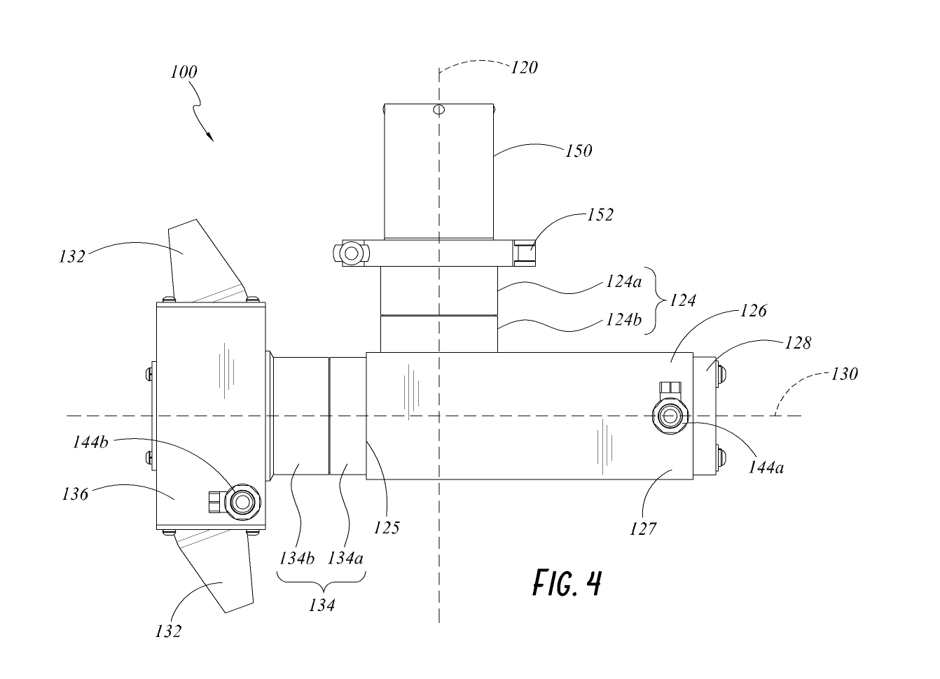

FIG. 4 is a front elevation view of the distribution manifold 100 of FIG. 3. As noted above, the first chamber 126 can rotate about the first rotational axis 120 on the first rotational coupling 124. The second air distribution chamber 136 can rotate about the second rotational axis 130 through the second rotational coupling 134. Additionally, the second chamber 136 can rotate about axis 120 along with first chamber 126.

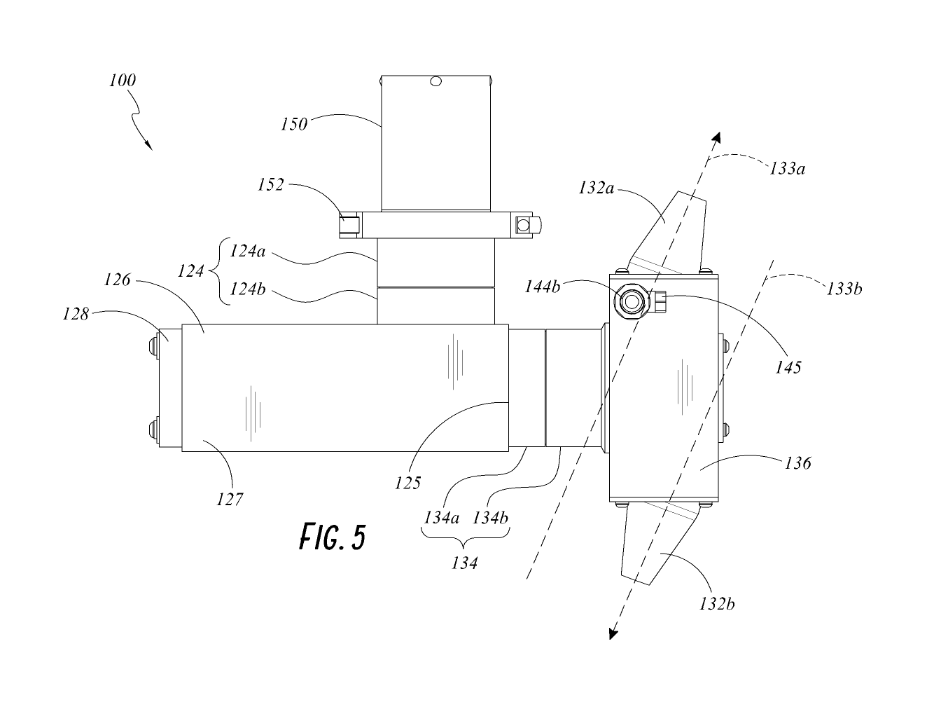

FIG. 5 is a back view the air distribution manifold 100 of FIGS. 3 and 4. A shown, optionally, the air distribution nozzles 132a, b can each be set at an angle relative to the second air distribution chamber 136 and/or to the first axis of rotation 120. The air distribution nozzle 132a can be aligned along direction 133a. Optionally, the second nozzle 132b is aligned along a direction 133b that can also be set at an angle relative to the second air distribution chamber 136 and/or to the first axis of rotation 120. In the illustrated embodiment, the first air nozzle 132a is pointed in a direction 133a that is directly opposite the direction 133b of the second air nozzle 132b. Accordingly, in the illustrated embodiment, the first nozzle 132a can be pointed away from the axis of rotation 120 and the second nozzle 132b can be pointed towards the axis of rotation 120. As noted above, in certain embodiments, the first and second air nozzles 132a, b can also be pointed in opposite directions. In such a configuration, the air that flows out of air distribution nozzles 132a and 132b can be balanced, which can provide more stability for the rotation of the second air chamber 136 as it rotates at high speeds. Additionally, by pointing each nozzle in opposite directions the rotating second air distribution chamber 136 can allow the nozzles to cover more surface area and thus dry or particle remove more efficiently.

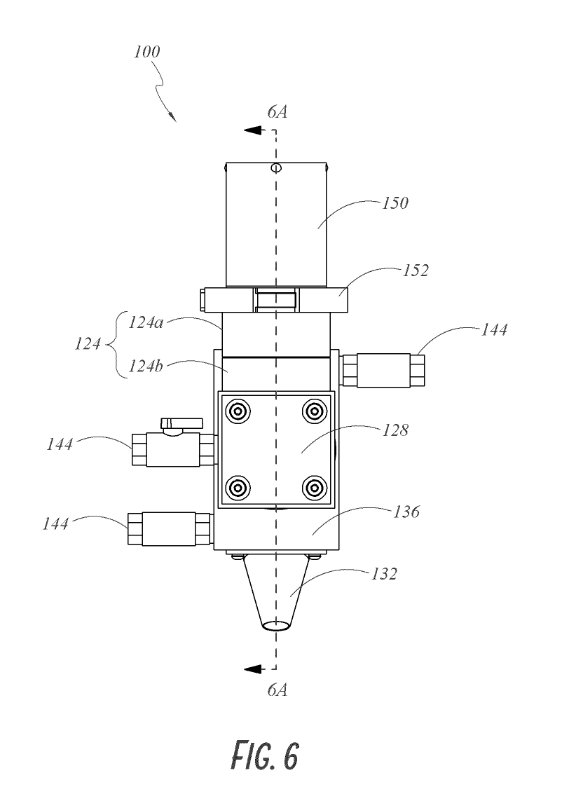

FIG. 6 is a side view of rotational the air distribution manifold 100 of FIGS. 3-5.

FIG. 6A is a cross-sectional vie of the rotational air distribution manifold 100 of FIG. 6 taken along line 6A-6A of FIG. 6.

FIG. 6B is a detail view of the portion of FIG. 6A labeled 6B-6B and includes an illustration of an embodiment of the second rotational coupling 134. Optionally, the first rotational coupling 124 can have the same or substantially same structure as the second aired several rotational coupling 134. Moreover the structure of second air distribution chamber shown in FIG. 6B can be applied to each of the embodiments shown throughout this application.

With reference to FIG. 6B, optionally, the second rotational coupling 134 can comprise a first section 134a that is a part of the first air distribution chamber 126. The second rotational coupling 134 can comprise a second section 134b that is a part of the second air distribution chamber 126. In some embodiments, the first coupler section 134a comprises at least one wing portion 160. Wing portion 160 can include a central section 160a in which a mechanical fastener 161 can be inserted. Optionally, the wing portion 160 is non-removable coupled with the rest of first section 134a. Optionally, first section 134a comprises a plurality of wing portions 160.

Optionally, the second section 134b comprises at least one second wing portion 162 and a second central portion 162a. The mechanical fastener 161 can pass through the second central section 160 and the second the second sectional section 162 a of second wing portion 162. Optionally, first section 134b comprises a plurality of wing portions 162.

In some embodiments, the first section 134a and the second section 134b of the second rotational coupling 134 can be rotatably mounted together through mechanical fastener 161. The mechanical fastener 161 can couple also optionally the first wing portion 160 with the second wing portion 162. In some embodiments, the first and second wing portions 160 and 162 can each include wing portions that couple the central portions 160a and 162a. Optionally, the peripheral interface 172 between the first section 134a and the second section 134b can be a tongue-and-groove type interface. The peripheral interface can function to eliminate or reduce the amount of leakage of the pressurized air from the interior of the air distribution manifold 100.

Optionally, the first and second sections 134a,b can also cooperate with at least one cylindrical bearing. As illustrated in FIG. 6B, the second rotational coupling 134 (or first rotational coupling 124) can optionally comprise two cylindrical bearings, a proximal bearing 180 and a distal bearing 182, which can provide improved operation of the rotary coupling compared with the use of a single bearing when the present air delivery devices are operated with overhung loads or under unbalanced conditions. The proximal bearing 180 can be retained between the central sections 160a, 162a at a position proximal to the distal bearing 182. The distal bearing 182 can be retained on the central section 162a distally with respect to the proximal bearing 180, and preferably is retained at the distal end 165 of the central section 162a around at least a portion of the distal end 165 of the central section 162a, as shown in FIG. 6B. The bearings 180 and 182 can each comprise a cylindrical center opening, 181 and 183 respectively, configured to allow the bearings 180 and 182 to fit over and cooperate with the mechanical fastener 161. The bearings 180 and 182 further are preferably sealed and permanently greased lubed bearings.

Optionally, the second air chamber 136 can include an access panel 137 as shown in FIG. 6A. The access panel 137 can provide access to the mechanical fastener 161 of the second air distribution coupling 134. The access panel 137 can be held in place by a mechanical fasteners 137a. Similarly, access can optionally be provided to the mechanical fastener 161a of the first air distribution coupling 124 through an opening 150a of shaft 150 as illustrated in FIG. 6A.

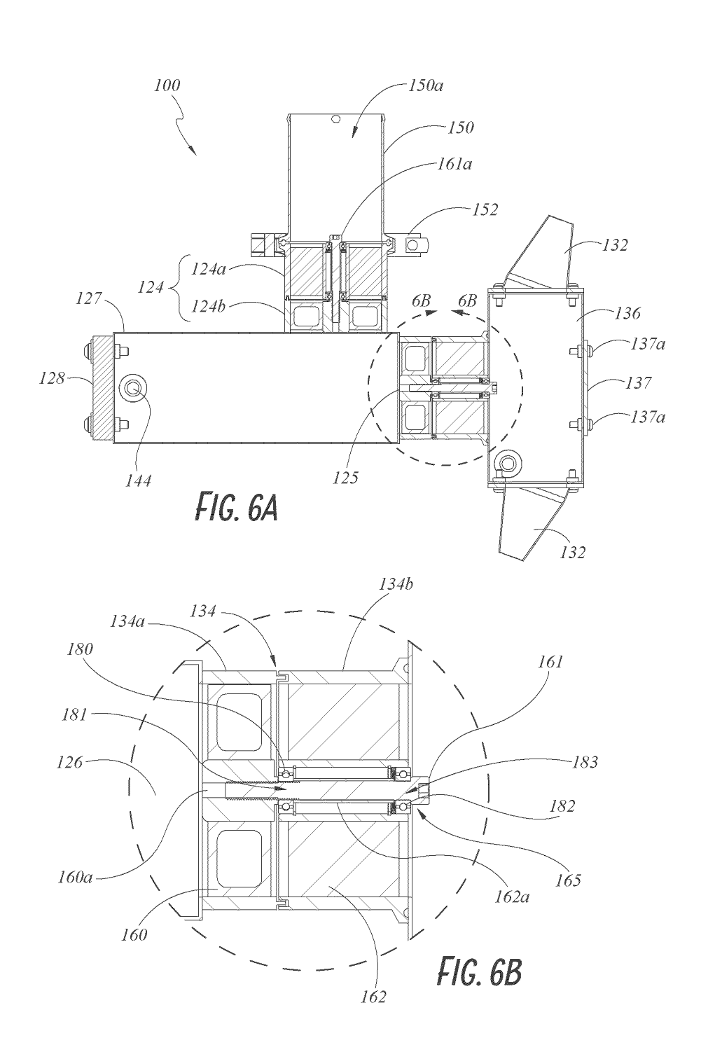

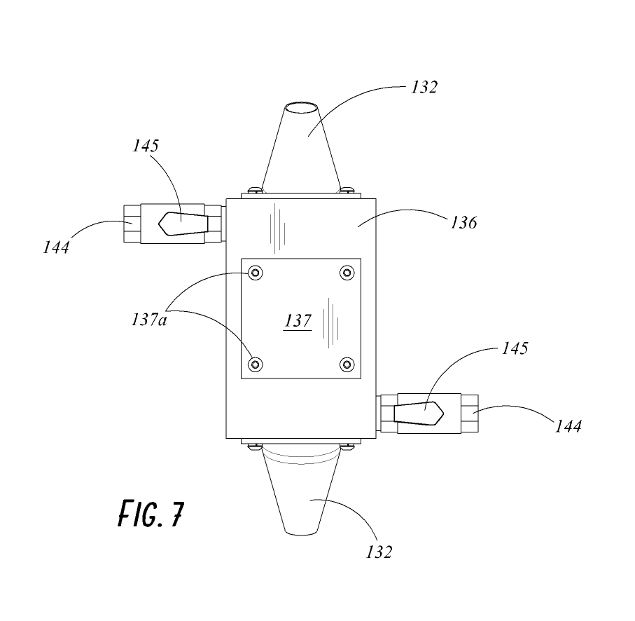

FIG. 7 is a side view of the second air distribution chamber 136 off FIGS. 3-6. As noted above, optionally, the second air distribution chamber 136 can comprise a removable access panel 137.

In the illustrated embodiment, the air second air distribution chamber 136 includes the first and second thrust jets 144a, 144b, which can be coupled to the second air distribution chamber 136 on opposite sides of the air distribution chamber 136. In some embodiments, the pair of thrust jets 144a, b are offset from the rotational access axis of the second air distribution chamber 136 such that a pressurized air emanating from the pair of thrust jets 144a, b can provide a rotational velocity to the second air distribution chamber 136. Optionally, the pair of thrust jets 144a, b are equally offset from the axis of rotation. In other embodiments of the second air distribution chamber 136 only one thrust jet is included. In other embodiments of the second air distribution chamber 136 more than two thrust jets are included in the second air distribution chamber 146.

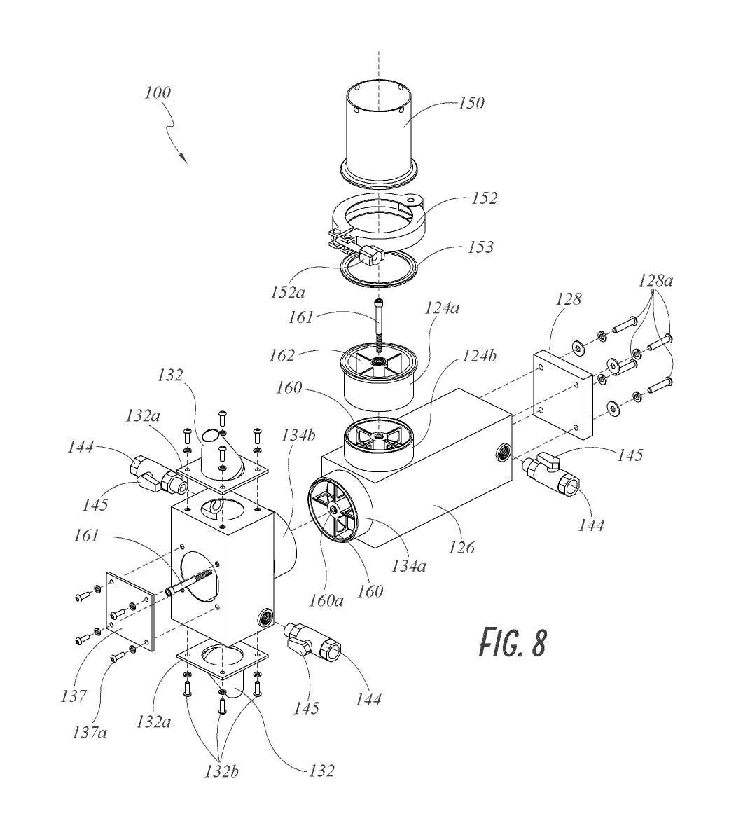

FIG. 8 is an exploded perspective view of the rotational air distribution manifold 100 illustrated in FIGS. 3-7. As noted above, optionally, the shaft 150 is coupled with upper portion of the first rotational coupling 124 by the coupler 152. As illustrated, the coupler 152 can include a gasket 153.

As shown in FIG. 8, in the illustrated embodiment, the air nozzles 132 can be fastened to the second air distribution chamber 136 by mechanical fasteners 132b. The air nozzles 132 can also be made an integral part of the second air distribution chamber 136 in certain embodiments.

As shown in FIG. 8, the lower portion 124b of first rotational coupling 124 can include the first wing portion 160. The first wing portion 160 can be configured at a central portion 160a and can otherwise be configured to allow for pressurized air to flow freely through lower section 124b. Similarly, the upper section 124a can comprise the second wing portion 162 that is configured to have a central portion 162a and otherwise be configured to allow for the free flow of air through the upper section 124a of first rotation of coupler coupling 124.

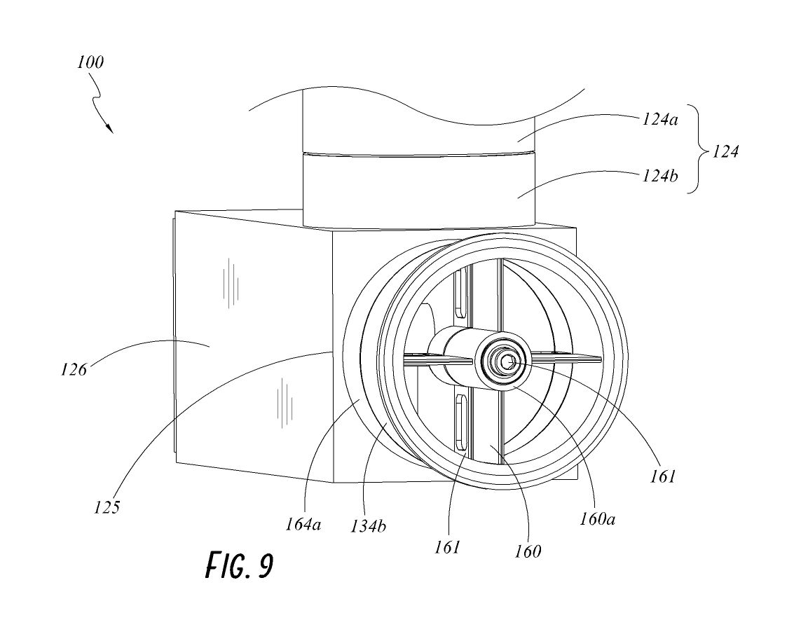

FIG. 9 is a perspective view of an embodiment of the second rotational coupling 134. As seen in this view of the second rotational coupler 134b, the first air distribution chamber 126 can be fluidly coupled with the second air distribution chamber 134 such that at a pressurized air can flow freely between the first air distribution channel 126 and second air distribution chamber 136. The first rotational air coupling 124 can be structured similar to the embodiment of the second coupler 134 shown in FIG. 9.

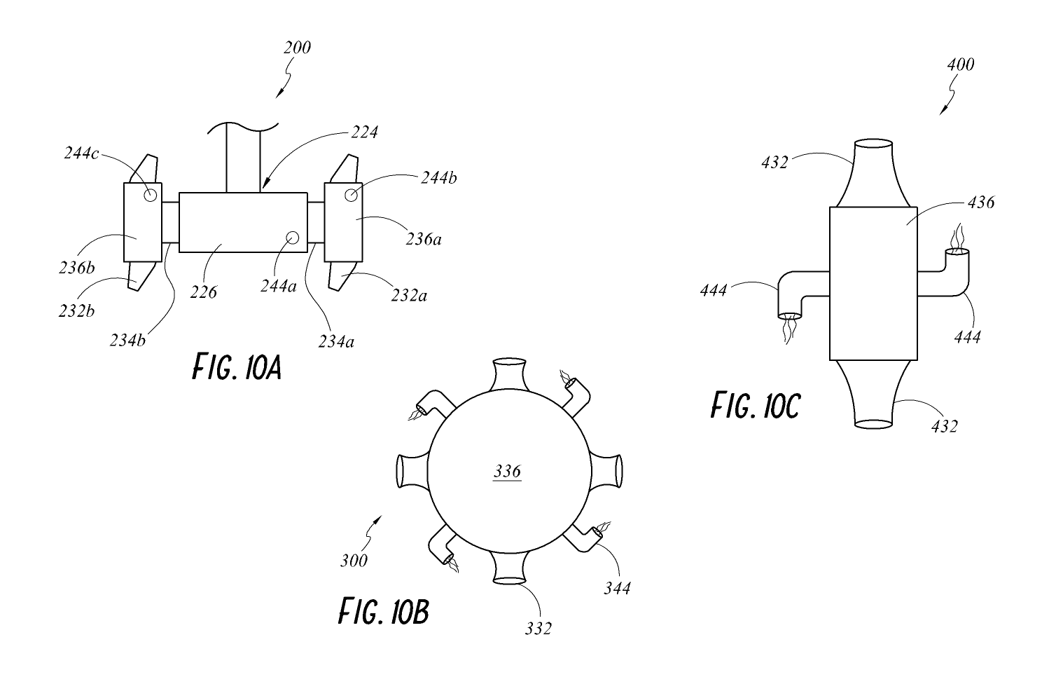

FIG. 10 is contains several additional embodiments of the present disclosure. FIG. 10A illustrates an embodiment of a rotational air distribution assembly 200 comprising first air distribution chamber 226, a second air distribution chamber 236a, and a third air distribution chamber 236b. In this embodiment, the first air to distribution chamber to 226 rotates about a first rotational coupling 224. The second air distribution chamber 236a rotates with respect to the first air distribution chamber 226 through second rotational coupling 234a. The third air distribution chamber 236b rotates with respect to the first air distribution chamber 226 through a third rotational coupling 234b.

Optionally, the rotation of the first air distribution chamber 226 on about the first rotational coupling to 224 can be achieved through a thrust jet to 244a that is on the first chamber 224 and offset from the central axis of the rotational coupling 224. The rotation of the second air distribution chamber 236a on about the second rotational coupling to 234a is achieved through a thrust jet to 244b that is on the second chamber 224 and offset from the central axis of the rotational coupling 234a. The rotation of the third air distribution chamber 236b on about the second rotational coupling to 234b is achieved through a thrust jet to 244c that is on the third chamber 224 and offset from the central axis of the rotational coupling 234a. In other embodiments, such as that shown in FIGS. 10c and 10b, each of the thrust jets 244 can include an angled bend and be aligned with the axes of rotation instead of being offset from it.

FIG. 10B is an additional embodiment of a second air distribution chamber 336. In this embodiment, the second air distribution chamber 336 is circular with air nozzles 344 placed at locations around the periphery of the air distribution chamber 336. Optionally, the thrust jets 344 provide the chamber 336 with rotational velocity about a central axis of the second air distribution chamber 336. The thrust jet 344 can be optionally aligned with the axes of rotation of the second air distribution chamber 336 and provide a force tangential to the axis of rotation.

FIG. 10C is an another embodiment of a second air distribution chamber 436. In this embodiment, thrust jets 444 can be aligned with the axis of rotation of the second air distribution chamber 436, instead of offset from it, and still provide rotational velocity to the second air chamber 436.

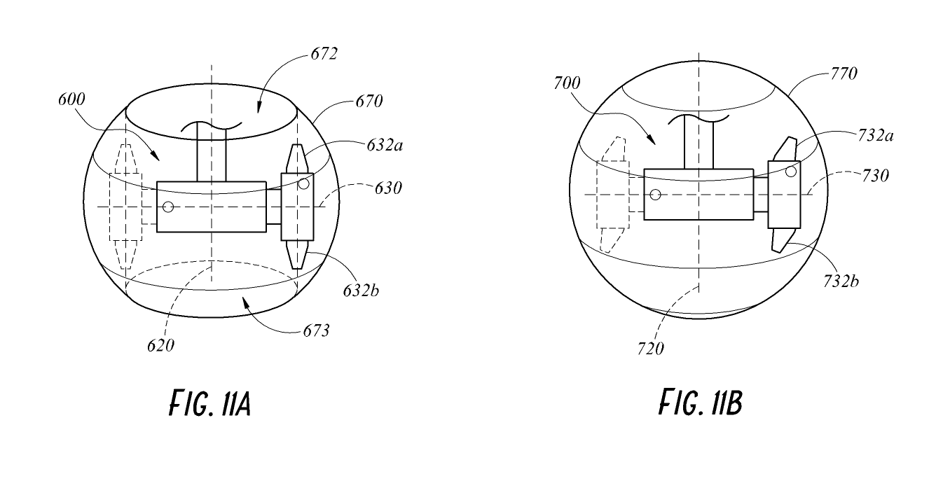

FIGS. 11A-11B are illustrations of various embodiments of a rotational air distribution manifold and the spray patterns that are achievable by certain configurations of the pressurized air nozzles in combination with the number of axes of rotation.

FIG. 11A illustrates another embodiment of the present disclosure, rotational air distribution assembly 600 having an outward spray pattern 670. Spray pattern 670 is the hemispherical spray pattern achievable by the air emanating from air nozzles 632a and 632b as they rotate about second rotational axis 630 and first rotational axis 620. When the orientation of air nozzles 732a and 732b are both oriented parallel to the first rotational axis 620, or at any angle in a direction away from the first rotational axis, 620, then outward spray pattern 670 includes dead spots, 672 and 673 at the north and south poles of the spray pattern, respectively. These dead spot provide the advantage of allowing certain areas to not be sprayed by the air distribution manifold 600 and are the preferred spray pattern for some applications.

FIG. 11B is an embodiment of the present disclosure comprising rotational air distribution assembly 700 and spray pattern 770. As illustrated in FIG. 11B, outward spray pattern 770 does not comprise any dead zones in a fully spherical pattern. In some applications of the disclosure, this type of spray pattern is preferred. This pattern is achieved by one of the nozzles 732 being oriented to emit pressurized air in a direction towards the first axis of rotation 720.

For purposes of summarizing the inventions disclosed herein and the advantages achieved over the prior art, certain objects and advantages of the certain embodiments are described herein. Of course, not all such objects or advantages need to be achieved in accordance with any particular embodiment. Thus, for example, those skilled in the art will recognize that the inventions may be embodied or carried out in a manner that achieves or optimizes one advantage or group of advantages as taught or suggested herein without necessarily achieving or optimizing other objects or advantages as may be taught or suggested herein.

Conditional language used herein, such as, among others, “optionally” “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. Similarly, omission of conditional language does not indicate that a described feature is a necessary requirement of a disclosed embodiment or the disclosed musical instrument.

Discussion of the various embodiments herein has generally followed the embodiments schematically illustrated in the figures. Many variations and modifications may be made to the herein-described embodiments, the elements of which are to be understood as being among other acceptable examples. All such modifications and variations are intended to be included within the scope of this disclosure. For example, it is contemplated that the particular features, structures, or characteristics of any embodiments discussed herein may be combined, or form sub-combinations in any suitable manner in one or more separate embodiments not expressly illustrated or described. Accordingly, although the present teachings have been described with reference to these specific embodiments, the descriptions are intended to be illustrative and are not intended to be limiting. Various modifications and applications may occur to those skilled in the art without departing from the spirit and scope of the teachings described herein.

What is claimed is:

1. A system for directing air under pressure comprising:
a blower; and
an air distribution manifold comprising:
a first air distribution chamber having a first end laterally spaced from a second end along a longitudinal axis, the first air distribution chamber having an inlet duct that is fluidly coupled to the blower, the inlet duct located between the first end and the second end of the first air distribution chamber and defining a first axis of rotation transverse to the longitudinal axis;
a first rotational coupling that joins the first air distribution chamber to the inlet duct and permits rotation of the first air distribution chamber relative to the inlet duct about the first axis of rotation;
a second air distribution chamber located on the first end of the first air distribution chamber and defining a second axis of rotation parallel to the longitudinal axis of the first distribution chamber, the second air distribution chamber having first and second lateral ends and a first nozzle for directing air under pressure in a first outward direction;
a second rotational coupling that joins the first air distribution chamber to the second air distribution chamber and permits rotation of the first air distribution chamber relative to the second air distribution chamber about the second axis of rotation; and
a first thrust jet located on at least one of the first and second lateral ends of the second air distribution chamber and configured to emit a jet of air tangentially relative to the second axis of rotation.

2. The system for directing air under pressure of claim 1 wherein the first air distribution chamber further comprises a second thrust jet located on the second end of the first air distribution chamber and configured to emit a jet of air tangentially relative to the first axis of rotation.

3. The system for directing air under pressure of claim 1 wherein pressurized air is communicated from the blower through the inlet duct, into the first air distribution chamber, into the second air distribution chamber, and out through the first thrust jet and the first nozzle.

4. The system for directing air under pressure of claim 1 further comprising a counterweight on the second end of first air distribution chamber.

5. The system for directing air under pressure of claim 1 wherein the second air distribution chamber further comprises a second nozzle on one of the first and second lateral ends opposite the first nozzle.

6. The system for directing air under pressure of claim 5 wherein the second nozzle is directed in a second outward direction, the second outward direction being substantially opposite the first outward direction.

7. The system for directing air under pressure of claim 1 further comprising a third nozzle on the first air chamber located between the first end and the second end of the first air chamber.

8. An apparatus for directing air under pressure comprising:
a first air distribution chamber having an air inlet, the air inlet defining a first axis of rotation and comprising a first rotational coupling;
a second air distribution chamber fluidly coupled with the first air chamber at an air passage, the air passage defining a second axis of rotation and comprising a second rotational coupling;
the second air distribution chamber further comprising a first nozzle for directing air under pressure in an outward direction and a first thrust jet located on the second air chamber;
wherein the thrust jet is configured to direct a jet of air tangentially relative to the second axis of rotation sufficient to rotate the second air chamber about the second axis of rotation.

9. The apparatus for directing air under pressure of claim 8 further comprising a second thrust jet located on the first air chamber and configured to direct a jet of air tangentially relative to the first axis of rotation sufficient to rotate the first air chamber about the first axis of rotation.

10. The apparatus for directing air under pressure of claim 9, wherein rotation about the first and second axes of the apparatus is achieved without motors, gears, or control devices except for a plurality of thrust jets.

11. The apparatus for directing air under pressure of claim 9 wherein the second thrust jet is located on the first air chamber at a location offset from the first axis of rotation.

12. The apparatus for directing air under pressure of claim 8 further comprising a second nozzle located on the second air chamber.

13. The apparatus for directing air under pressure of claim 12 wherein the first nozzle is directed in a first outward direction and the second nozzle is directed in a second outward direction, the first outward direction being different than the second outward direction.

14. The apparatus for directing air under pressure of claim 8 wherein the first thrust jet comprises an adjustment mechanism to vary the jet of air emitted from the first thrust jet.

15. The apparatus for directing air under pressure of claim 14 wherein the first air distribution chamber is configured to rotate about the first axis of rotation at a first rotational velocity and the second air distribution chamber is configured to rotate about the second axis of rotation at a second rotational velocity.

16. A method for directing a flow of air comprising:
delivering a flow of air into a first distribution chamber;
rotating the first distribution chamber about a first axis;
directing the flow of air from the first distribution chamber into a second distribution chamber;
emitting a jet of air from the second distribution chamber and thereby rotating the second distribution chamber about a second axis;
discharging from a nozzle the flow of air from the second distribution chamber in an outward direction.

17. The method for directing a flow of air of claim 16 wherein the flow of air is discharged in a hemispherical sweep pattern.

18. The method for directing a flow of air of claim 16 wherein the flow of air is discharged in a spherical sweep pattern.

19. The method of directing a flow of air of claim 16, wherein rotating the first distribution chamber about a first axis comprises emitting a jet of air from the first distribution chamber.

20. An apparatus for directing a flow of air comprising:
an air distribution manifold having a longitudinal axis of rotation and a transverse axis of rotation;
the air distribution manifold configured with at least one nozzle to emit a flow of air in a direction along a laterally extending swath;
wherein the air distribution manifold is equipped with at least a first thrust jet at a first location offset from the longitudinal axis of rotation and oriented tangentially relative to the longitudinal axis of rotation and a second thrust jet at second location offset from the transverse axis of rotation and oriented tangentially relative to the transverse axis of rotation and configured to rotate the air distribution manifold about the longitudinal axis of rotation and to rotate the air distribution manifold about the transverse axis of rotation, thereby sweeping the laterally extending swath in an outward direction.

21. An apparatus for directing a flow of air of claim 20 wherein the laterally extending swath is swept in a hemispherical sweep pattern.

22. An apparatus for directing a flow of air of claim 20 wherein the laterally extending swath is swept in a spherical sweep pattern.
